(19) United States
(12) Patent Application Publication
(10) Pub. No.: US 2026/0175752 A1
(43) Pub. Date: Jun. 25, 2026

(54) RECLINING DEVICE AND VEHICLE SEAT

(71) Applicants: NHK SPRING CO., LTD., Yokohama-shi (JP); SUBARU CORPORATION, Tokyo (JP)

(72) Inventors: Hiroshi YAGAME, Yokohama-shi (JP); Yuhei TSUKUTA, Yokohama-shi (JP); Masaya SHODA, Yokohama-shi (JP); Noriyuki FUKUCHI, Yokohama-shi (JP); Fumito KITANAKA, Tokyo (JP); Masato FUKUSHIMA, Tokyo (JP); Ayaka KASHIWAGI, Tokyo (JP)

(21) Appl. No.: 19/425,538

(22) Filed: Dec. 18, 2025

(30) Foreign Application Priority Data
Dec. 20, 2024 (JP) 2024-225727

(51) Int. Cl. B60N 2/433; B60N 2/22; B60N 2/42

(52) U.S. Cl. CPC B60N 2/433; B60N 2/22; B60N 2/4235

(57) ABSTRACT

In a reclining device, a lock mechanism locks tilting of a seat back. A knob is connected to a lock mechanism, and in a case in which the knob is operated, the lock mechanism unlocks tilting of the seat back. At a time of a side collision of a vehicle, the knob is bent and engaged with a restriction bracket, so that the operation of the knob is restricted. Therefore, the operation can be restricted by the impact load of the knob, and the unlocking of the tilting of the seat back can be restricted.

### CROSS-REFERENCE TO RELATED APPLICATION

This application is based on and claims priority under 35 USC 119 from Japanese Patent Application No. 2024-225727 filed on Dec. 20, 2024, the disclosure of which is incorporated by reference herein.

### BACKGROUND

### Technical Field

The present invention relates to a reclining device in which a lock mechanism locks tilting of a seat back, and a vehicle seat provided with the reclining device.

### Related Art

In a seat described in Japanese Patent Application Laid-Open (JP-A) No. 2000-108738, tilting of a seat back is locked, and a reclining lever is operated to unlock the tilting of the seat back.

In this seat, at the time of side collision of a vehicle, the operation of the reclining lever due to input of an impact load to the reclining lever is suppressed by a bracket for preventing upward shift of the lever, and unlocking of the tilting of the seat back is suppressed.

### SUMMARY

In view of the above fact, an object of the invention is to provide a reclining device and a vehicle seat which can regulate unlocking of tilting of a seat back at the time of side collision of a vehicle.

A reclining device of a first aspect of the invention includes: a lock mechanism locking tilting of a seat back in a vehicle seat; an operation member connected to the lock mechanism, the operation member being operated so that the lock mechanism unlocks tilting of the seat back; and an engaging member engaged with the operation member due to an impact load being input to the operation member to bend the operation member at a time of a side collision of a vehicle, so that the operation of the operation member is restricted.

In the reclining device of the first aspect of the invention, the lock mechanism locks tilting of the seat back in the vehicle seat. The operation member is connected to the lock mechanism, and the operation member is operated so that the lock mechanism unlocks tilting of the seat back.

The operation member is engaged with the engaging member due to an impact load being input to the operation member to bend the operation member at the time of a side collision of the vehicle, so that the operation of the operation member is restricted. Therefore, unlocking of tilting of the seat back can be restricted.

In a reclining device of a second aspect of the invention in the reclining device of the first aspect of the invention, bending of the operation member is releasable after the operation member has been engaged with the engaging member.

In the reclining device of the second aspect of the invention, bending of the operation member is releasable after the operation member has been engaged with the engaging member. Therefore, the operation member can be disengaged from the engaging member, and the operation member can be operated.

In a reclining device of a third aspect of the invention in the reclining device of the first or second aspect of the invention, the operation member is engaged with the engaging member on a front-rear direction side of the operation member with respect to a rotation axis thereof.

In the reclining device of the third aspect of the invention, the operation member is engaged with the engaging member on the front-rear direction side of the operation member with respect to the rotation axis. Therefore, the operation member can be appropriately engaged with the engaging member by a large bending amount due to the impact load of the operation member on the front-rear direction side of the operation member with respect to the rotation axis thereof.

A reclining device of a fourth aspect of the invention in the reclining device of any one of the first to third aspects of the invention includes an operation portion that is provided at the operation member and that is operated, in which the operation member is engaged with the engaging member on an operation portion side of the operation member with respect to a rotation axis thereof.

In the reclining device of the fourth aspect of the invention, the operation member is operated at the operation portion. The operation member is engaged with the engaging member on the operation portion side of the operation member with respect to the rotation axis thereof. Therefore, the operation portion can be moved to release the bending of the operation member, and the operation member can be easily disengaged from the engaging member.

A reclining device of a fifth aspect of the invention in the reclining device of any one of the first to fourth aspects of the invention includes: an engagement hole provided at one of the operation member or the engaging member; and an insertion portion provided at another of the operation member or the engaging member, the insertion portion being inserted into the engagement hole to engage the operation member with the engaging member.

In the reclining device of the fifth aspect of the invention, the insertion portion of the other of the operation member or the engaging member is inserted into the engagement hole of one of the operation member or the engaging member, and the operation member is engaged with the engaging member. Therefore, with a simple configuration, the operation member can be engaged with the engaging member.

A vehicle seat of a sixth aspect of the invention includes: a seat cushion; a seat back; and the reclining device of any one of the first to fifth aspects provided between the seat cushion and the seat back.

In the vehicle seat of the sixth aspect of the invention, the reclining device of any one of the first to fifth aspects of the invention is provided between the seat cushion and the seat back. Therefore, the same effects as those of any one of the first to fifth aspects of the invention can be obtained.

### BRIEF DESCRIPTION OF THE DRAWINGS

Exemplary embodiments of the present invention will be described in detail based on the following figures, wherein:

FIG. 1 is an exploded perspective view illustrating a vehicle seat according to an embodiment of the invention as viewed from a diagonally front left side;

FIG. 2 is a side view illustrating the vehicle seat according to the embodiment of the invention as viewed from a left side;

FIG. 3 is a cross-sectional view (a cross-sectional view taken along line 3-3 in FIG. 2) of the vehicle seat according to the embodiment of the invention as viewed from an upper side; and

FIG. 4 is a side view illustrating a restriction bracket and the like in the vehicle seat according to the embodiment of the invention as viewed from a left side.

### DETAILED DESCRIPTION

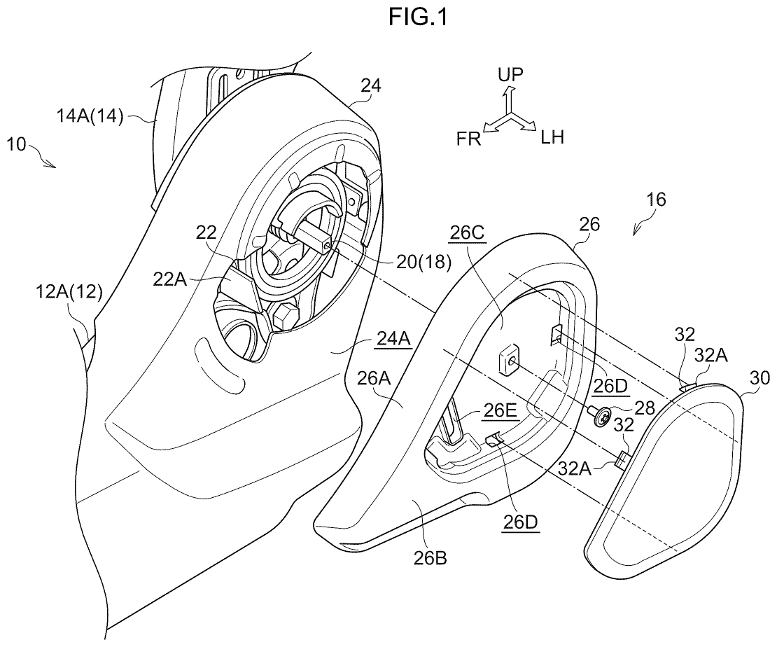

FIG. 1 is an exploded perspective view illustrating a vehicle seat 10 according to an embodiment of the invention as viewed from a diagonally front left side. In the drawings, the front side of the vehicle seat 10 is indicated by an arrow FR, the left side (outside in a vehicle width direction) of the vehicle seat 10 is indicated by an arrow LH, and the upper side of the vehicle seat 10 is indicated by an arrow UP.

The vehicle seat 10 according to this embodiment is provided on the front side and the left side of a vehicle interior of a vehicle (automobile), and a B-pillar of the vehicle is disposed near the left side of a rear end portion of the vehicle seat 10. A seat cushion 12 is provided below the vehicle seat 10, and an occupant of the vehicle is seated on the seat cushion 12. A seat back 14 is provided on the upper side of a rear end portion of the seat cushion 12, and the seat back 14 supports the back of the occupant.

As illustrated in FIG. 1, a reclining device 16 is provided between a cushion hinge 12A of the seat cushion 12 and a back hinge 14A of the seat back 14.

A lock mechanism 18 is provided in the reclining device 16, and the lock mechanism 18 locks tilting of the seat back 14 (back hinge 14A). The lock mechanism 18 is provided with a shaft 20 made of a metal as a rotation axis, and the shaft 20 extends leftward and has a portion, which is formed in a substantially rectangular columnar shape, other than a proximal end portion (right end portion).

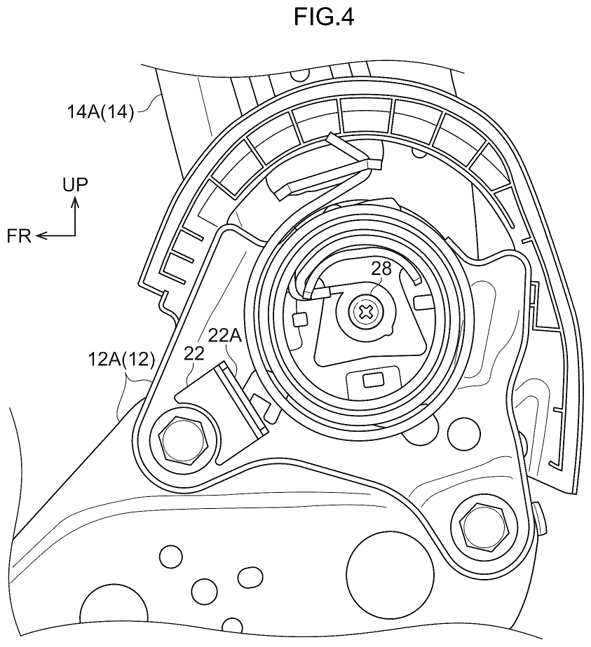

A restriction bracket 22 (see FIG. 4) having an L-shaped cross section plate shape and made of a metal as an engaging member is disposed on the front side of the shaft 20, and a proximal end side portion of the restriction bracket 22 is fixed to a rear portion of the cushion hinge 12A and is disposed perpendicular to the right-left direction. A distal end side portion of the restriction bracket 22 is an insertion portion 22A having a rectangular plate shape as an engaged portion, and the insertion portion 22A protrudes leftward and is disposed perpendicular to the radial direction of the shaft 20.

A cover 24 made of a resin as an arrangement member is provided on the left side of the lock mechanism 18, and the cover 24 covers a portion from a rear portion of the seat cushion 12 to a lower end portion of the seat back 14 from the left side. An arrangement recess 24A having a substantially trapezoidal shape in front view is formed in a rear portion of the cover 24, and the arrangement recess 24A is opened to the left side, the upper side, the front side, and the rear side. A part of the bottom wall (right wall) of the arrangement recess 24A is opened, and a distal end portion (left end portion) of the shaft 20 and a distal end portion (left end portion) of the insertion portion 22A of the restriction bracket 22 are disposed in the arrangement recess 24A.

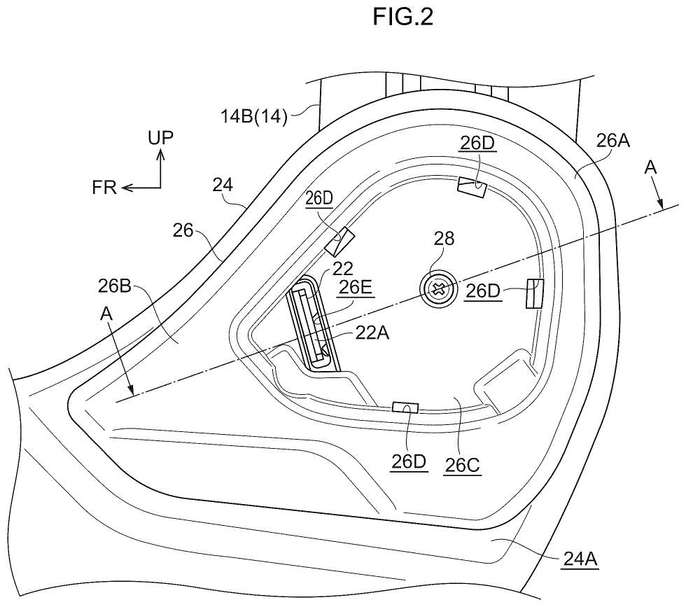

In the arrangement recess 24A, a knob 26 (see FIG. 2) having a substantially trapezoidal plate shape and made of a resin as a body member constituting an operation member is disposed. A tubular peripheral wall 26A is integrally provided on the entire circumference of the knob 26, and the peripheral wall 26A protrudes rightward. A front portion of the knob 26 is an operation portion 26B having a substantially triangular shape in front view, and the operation portion 26B protrudes forward. A coupling recess 26C having a substantially trapezoidal shape in front view is formed in the knob 26, and the coupling recess 26C is opened to the left side. A rectangular coupling hole 26D as a coupled portion is formed to penetrate through an upper portion, a lower portion, a front portion, and a rear portion of a peripheral portion of the coupling recess 26C.

A central portion of a bottom wall (right wall) of the coupling recess 26C is fixed (connected) to the distal end portion of the shaft 20 by a screw 28, and the knob 26 is integrally rotatable with the shaft 20 with the shaft 20 as a rotation axis. In a case in which the knob 26 is operated to rotate upward in the operation portion 26B by the occupant, the shaft 20 of the lock mechanism 18 is rotated, and the lock mechanism 18 unlocks the tilting of the seat back 14.

An engagement hole 26E having an elongated rectangular shape as an engagement portion is formed to penetrate through the bottom wall of the coupling recess 26C on the front side of the shaft 20, and the engagement hole 26E is disposed perpendicular to the radial direction of the shaft 20 and is opposed to the insertion portion 22A of the restriction bracket 22 in the right-left direction.

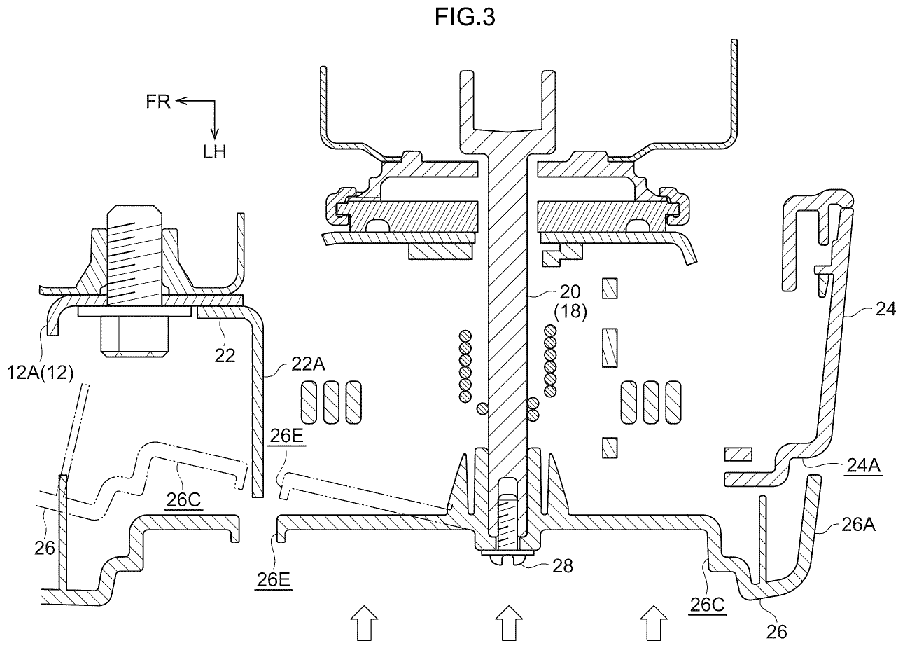

A cap 30 (see FIG. 3) having a substantially trapezoidal plate shape and made of a resin as a covering member constituting an operation member is fitted to the coupling recess 26C, and a left surface of the cap 30 is flush with a left surface (outer periphery) of the knob 26. A coupling claw 32 having a substantially rectangular plate shape as a coupling portion is integrally provided at an upper portion, a lower portion, a front portion, and a rear portion of the peripheral portion of the cap 30, and the coupling claw 32 extends rightward. A coupling protrusion 32A having a triangular prism shape is integrally provided at a distal end portion (right end portion) of the coupling claw 32, and the coupling protrusion 32A protrudes to the outer peripheral side of the coupling recess 26C and has a left surface disposed perpendicular to the right-left direction. The coupling claw 32 is inserted into the coupling hole 26D on a peripheral portion of the coupling recess 26C by temporary elastic deformation, and the coupling protrusion 32A is locked from the right side to the periphery of the coupling hole 26D on the peripheral portion of the coupling recess 26C, so that the leftward movement of the coupling protrusion 32A is locked, and the leftward movement of the cap 30 is locked, whereby the cap 30 is integrally rotatably coupled to the knob 26.

Next, the operation of this embodiment will be described.

In the reclining device 16 of the vehicle seat 10 having the above configuration, the lock mechanism 18 locks the tilting of the seat back 14. The knob 26 is fixed to the shaft 20 of the lock mechanism 18 and is integrally rotatable with the shaft 20. In a case in which the knob 26 (including the cap 30) is operated to rotate upward in the operation portion 26B, the shaft 20 is rotated integrally with the knob 26, and the lock mechanism 18 unlocks the tilting of the seat back 14.

In a case in which an impact load from the B-pillar of the vehicle is input to the knob 26 at the time of side collision of the vehicle to bend the knob 26 rightward (inward in the vehicle width direction), the insertion portion 22A of the restriction bracket 22 is inserted into the engagement hole 26E of the knob 26, and the knob 26 is engaged with the restriction bracket 22, so that the restriction bracket 22 restricts the rotational operation of the knob 26 (see a two-dot chain line in FIG. 3). Therefore, the rotational operation can be restricted by the impact load of the knob 26, the unlocking of the tilting of the seat back 14 can be restricted, and the unnecessary tilting of the seat back 14 can be restricted.

As described above, the insertion portion 22A of the restriction bracket 22 is inserted into the engagement hole 26E of the knob 26, and the knob 26 is engaged with the restriction bracket 22. Therefore, with a simple configuration, the knob 26 can be engaged with the restriction bracket 22.

In a case in which the knob 26 has a large bending amount to the right side due to the impact load on the front side and the rear side of the shaft 20, the knob 26 is engaged with the restriction bracket 22 (insertion portion 22A) on the front side (engagement hole 26E) of the shaft 20. Therefore, the knob 26 can be appropriately engaged with the restriction bracket 22, and the restriction bracket 22 can appropriately restrict the rotational operation of the knob 26.

After the side collision of the vehicle (after the knob 26 is engaged with the restriction bracket 22), the knob 26 is moved to the left side to release the bending of the knob 26, so that the knob 26 is disengaged from the restriction bracket 22. Therefore, the knob 26 can be operated to rotate, the tilting of the seat back 14 can be unlocked, the seat back 14 can be tilted, and the occupant can escape to the outside of the vehicle, for example.

At the time of side collision of the vehicle, the knob 26 (engagement hole 26E) is engaged with the restriction bracket 22 (insertion portion 22A) on the operation portion 26B side of the knob 26 with respect to the shaft 20. Therefore, after the side collision of the vehicle, the operation portion 26B is moved leftward by the occupant, so that the bending of the knob 26 can be released, and the knob 26 can be easily disengaged from the restriction bracket 22.

In this embodiment, the engagement hole 26E is provided in the knob 26, and the insertion portion 22A is provided in the restriction bracket 22. However, the insertion portion 22A may be provided in the knob 26, and the engagement hole 26E may be provided in the restriction bracket 22.

In this embodiment, the knob 26 is engaged with the restriction bracket 22 on the front side of the shaft 20. However, the knob 26 may be engaged with the restriction bracket 22 on the rear side, the upper side, or the lower side of the shaft 20.

What is claimed is:

1. A reclining device comprising:
a lock mechanism locking tilting of a seat back in a vehicle seat;
an operation member connected to the lock mechanism, the operation member being operated so that the lock mechanism unlocks tilting of the seat back; and
an engaging member engaged with the operation member due to an impact load being input to the operation member to bend the operation member at a time of a side collision of a vehicle, so that the operation of the operation member is restricted.

2. The reclining device according to claim 1, wherein bending of the operation member is releasable after the operation member has been engaged with the engaging member.

3. The reclining device according to claim 1, wherein the operation member is engaged with the engaging member on a front-rear direction side of the operation member with respect to a rotation axis thereof.

4. The reclining device according to claim 1, comprising an operation portion that is provided at the operation member and that is operated, wherein the operation member is engaged with the engaging member on an operation portion side of the operation member with respect to a rotation axis thereof.

5. The reclining device according to claim 4, wherein the operation portion is provided so as to protrude from the operation member.

6. The reclining device according to claim 1, comprising:
an engagement hole provided at one of the operation member or the engaging member; and
an insertion portion provided at another of the operation member or the engaging member, the insertion portion being inserted into the engagement hole to engage the operation member with the engaging member.

7. A vehicle seat comprising:
a seat cushion;
a seat back; and
the reclining device according to claim 1 provided between the seat cushion and the seat back.
